(19) United States
(12) Patent Application Publication
(10) Pub. No.: US 2026/0370258 A1
(43) Pub. Date: Nov. 19, 2026

(54) COMMUNICATION METHOD AND COMMUNICATION SYSTEM

(71) Applicant: DENSO TEN Limited, Kobe-shi, Hyogo (JP)

(72) Inventors: Makoto OKUHARA, Kobe-shi (JP); Nobuyuki KURIOKA, Kobe-shi (JP)

(73) Assignee: DENSO TEN Limited, Kobe-shi, Hyogo (JP)

(21) Appl. No.: 19/477,549

(22) PCT Filed: Aug. 3, 2023
(86) PCT No.: PCT/JP2023/028413

§ 371 Date: Oct. 22, 2025

(51) Int. Cl. H04B 1/7163

(52) U.S. Cl. CPC H04B 1/71637; H04B 1/71632; H04B 2201/71634

(57) ABSTRACT

An exemplary method is a communication method using a preamble between a first communication device and a second communication device, wherein the first communication device communicates with the second communication device using a type of the preamble determined according to a use purpose of communication from among a plurality of preamble types determined by the pulse repetition frequency of the preamble or the length of the preamble.

### TECHNICAL FIELD

The present invention relates to communication technologies using a preamble.

### BACKGROUND ART

In the field of communications, wireless communication has been increasing in recent years because of their priority in installation or the like such as nonnecessity of interconnection lines. For example, UWB (Ultra Wide Band) communications using wideband radio waves are less susceptible to radio interference with radio waves that are used in Wi-Fi (registered trademark), smartphones or other portable terminals, and moreover excellent in transmissibility, UWB communications having been broadening their applications. Also, because UWB communications allow a communicatable state to be easily set up even in a vehicle interior which is a narrow space among metals and large amounts of interconnection lines, the UWB communications are expected as a communication means for on-vehicle equipment.

### LIST OF CITATIONS

### Patent Literature

Patent document 1: JP 2016-38332 A

### SUMMARY OF INVENTION

### Technical Problem

However, with UWB communications having come into widespread use, there is a probability that even UWB communications may more likely interfere between or among UWB communications, causing communication disruptions due to the interference. The problem of communication disruptions, without being limited to communication means for on-vehicle devices or to UWB communications, may also be caused even when a plurality of devices perform communications by using radio waves of the same frequency band.

In view of such problems as described above, there has been disclosed, in Patent Document 1, a technique of lowering a communication rate to prevent interference. However, it is desirable that interference can be prevented without lowering the communication rate. Also, when a plurality of use purposes of communication are involved, it is desirable that communication with a higher-priority (higher-importance) use purpose be higher in communication success rate than communication with a lower-priority (lower-importance) use purpose.

In view of these and other problems, an object of the present invention is to provide a technique which makes it implementable to improve the communication success rate in communications with a higher-priority use purpose.

### Solution to Problem

An exemplary communication method of the present invention is a communication method using a preamble between a first communication device and a second communication device, wherein the first communication device communicates with the second communication device using a type of the preamble determined according to a use purpose of communication from among a plurality of preamble types determined by the pulse repetition frequency of the preamble or the length of the preamble.

### Advantageous Effects of Invention

According to the exemplary present invention, since the preamble to be used in communication can be properly set according to a use purpose of communication, the communication success rate in communications with a use purpose of higher priority can be improved.

### BRIEF DESCRIPTION OF DRAWINGS

FIG. 1 is a view showing a configuration example of a communication system;

FIG. 2 is a chart showing a frame format to be used in UWB communications;

FIG. 3A is a chart showing a first determination pattern included in a first determination example of preamble type;

FIG. 3B is a chart showing a second determination pattern included in the first determination example of preamble type;

FIG. 3C is a chart showing a third determination pattern included in the first determination example of preamble type;

FIG. 4A is a chart showing a fourth determination pattern included in a second determination example of preamble type;

FIG. 4B is a chart showing a fifth determination pattern included in the second determination example of preamble type;

FIG. 4C is a chart showing a sixth determination pattern included in the second determination example of preamble type;

FIG. 4D is a chart showing a modification example of the fourth determination pattern;

FIG. 4E is a chart showing a modification example of the fourth determination pattern;

FIG. 5 is a chart showing a seventh determination pattern included in the third determination example of preamble type;

FIG. 6 is a schematic chart for explaining problems under a reception condition of UWB communications;

FIG. 7 is a schematic chart showing an outline of radio-interference countermeasures in a communication system;

FIG. 8 is a diagram showing a configuration example of a master communication device;

FIG. 9 is a flowchart showing an operation example of the master communication device;

FIG. 10 is a chart showing a data format example of a wireless communication schedule;

FIG. 11 is a diagram showing a configuration example of a slave communication device;

FIG. 12 is a flowchart showing an operation example of the slave communication device;

FIG. 13 is a schematic chart for explaining a detail example of a way of setting a reception-mode start time τₛₜₐᵣₜ;

FIG. 14 is a schematic chart showing an operation example of the communication system according to the wireless communication schedule;

FIG. 15 is a view showing a configuration example of a communication system according to a first modification example;

FIG. 16 is a diagram showing a relationship between a master communication device and a slave communication device included in the communication system according to the first modification example;

FIG. 17 is a diagram showing a configuration example of a communication system according to a second modification example;

FIG. 18 is a flowchart showing one example of processing executed by the master communication device during a calibration of radio output;

FIG. 19 is a chart for explaining operations of the master communication device and a slave communication device during execution of the processing shown in FIG. 18; and

FIG. 20 is a chart showing one example of a correlation map showing a relationship between inter-device distance and transmission power.

### DESCRIPTION OF EMBODIMENTS

Hereinbelow, an exemplary embodiment of the present invention will be described in detail with reference to the accompanying drawings. In the following description of the embodiment, like parts are designated by like reference signs and their redundant description will be omitted unless particularly necessitated.

### 1. Communication System

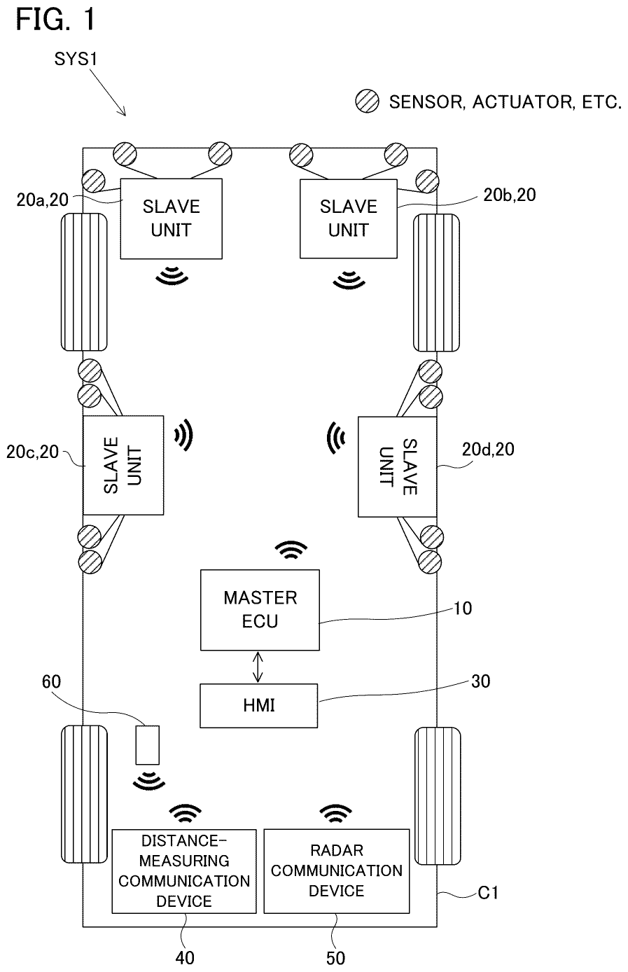

FIG. 1 is a view showing a configuration example of a communication system SYS1 according to an embodiment of the present invention. In this embodiment, the communication system SYS1 is mounted on a vehicle C1, as an example. However, the communication system SYS1 may also be applied to other than the vehicle C1, and may be utilized, for example, for mobile objects in general without being limited to automobiles as well as for household, office or factory purposes.

As shown in FIG. 1, the communication system SYS1 includes a master ECU (Electric Control Unit) 10, and a plurality of slave units 20a to 20d. The communication system SYS1 is a vehicle control system in which the master ECU 10, as an example, controls the individual slave units 20a to 20d by UWB communication in response to user's operations given to HMI (Human Machine Interface) 30. More specifically, each of the slave units 20a to 20d transmits to the master ECU 10 a sensor value detected by a sensor connected to the slave unit itself, or the like. Based on control signals transmitted from the master ECU 10, each of the slave units 20a to 20d controls an actuator connected to itself.

The first slave unit 20a is, for example, a control device for controlling drive of head lights. The second slave unit 20b is, for example, a control device for controlling drive of wipers. The third slave unit 20c is, for example, a control device for controlling drive of power windows. The fourth slave unit 20d is, for example, a control device for controlling drive of an air conditioner.

Since UWB communications are performed between the master ECU 10 and the individual slave units 20a to 20d, the master ECU 10 will hereinafter be referred to as master communication device 10, and the slave units 20a to 20d will hereinafter be referred to as slave communication devices 20a to 20d. Also, unless the plurality of slave communication devices 20a to 20d need to be distinguished from one another in explanation, the slave communication devices 20a to 20d may be referred to simply each as slave communication device 20.

In addition, although the slave communication devices 20 are provided in plurality in this embodiment, but may also be provided in singularity. Furthermore, although a plurality of control devices included in the communication system do not necessarily need to be in a relationship of master and slave, and may also be in an equal relationship to each other.

In this embodiment also, the master communication device 10 and the slave communication devices 20 perform UWB communications as described above. That is, wireless communications in this embodiment are wireless communications by UWB communication method. UWB communications are performed in compliance with standards such as IEEE 802.15.4 (hereinafter, referred to simply as communication standards from time to time). However, wireless communication may be preamble-utilized communication other than UWB communications, and may be, for example, Wi-Fi (registered trademark) communication, Bluetooth (registered trademark) communication, BLE (registered trademark, Bluetooth Low Energy) communication, LPWA (Low Power Wide Area) communication, Zigbee (registered trademark) communication, and the like.

The master communication device 10, on one hand, performs signal transmission to the slave communication devices 20 and, on the other hand, performs signal reception from the slave communication devices 20. Further, the slave communication device 20, on one hand, performs signal reception from the master communication device 10 and, on the other hand, performs signal transmission to the master communication device 10. That is, the communication system SYS1 includes both a transmission device for performing signal transmission by wireless communication and a reception device for performing signal reception by wireless communication. The master communication device 10 and the individual slave communication devices 20 are each enabled to serve as both the transmission device and the reception device. That is, the master communication device 10 serves as a transmission device under its signal transmission condition, and as a reception device in its signal reception condition. The slave communication devices 20 also each serve as a transmission device in its signal transmission condition, and as a reception device in its signal reception condition.

In this embodiment, the master communication device 10 and the individual slave communication devices 20a to 20d perform UWB communications. Therefore, the communication system SYS1 contributes to reduction of wire harness to be used in the vehicle C1.

The master communication device 10 and the slave communication devices 20 are communication devices of which use purpose of communication is data communication.

The communication system SYS1 further includes a distance-measuring (ranging) communication device 40 and a radar communication device 50.

In this embodiment, the distance-measuring communication device 40 and the radar communication device 50 each perform UWB communication. That is, wireless communication in each of the distance-measuring communication device 40 and the radar communication device 50 is wireless communication by UWB communication method. However, the wireless communication in each of the distance-measuring communication device 40 and the radar communication device 50 may also be preamble-utilized communication other than UWB communication and, for example, may be Wi-Fi communication, Bluetooth communication, BLE communication, LPWA communication, Zigbee communication, and the like.

The distance-measuring communication device 40 is a communication device of which use purpose of communication is distance-measuring communication. The distance-measuring communication device 40 performs wireless communication in association with an electronic key 60. The distance-measuring communication device 40 transmits a signal to the electronic key 60. The electronic key 60, after receiving the signal transmitted from the distance-measuring communication device 40, retransmits a return signal to the distance-measuring communication device 40. The distance-measuring communication device 40, upon receiving the return signal transmitted from the electronic key 60, measures a required time elapse from transmission of the signal until reception of the return signal, calculating a distance to the electronic key 60 based on the measured required time elapse.

The radar communication device 50 is a communication device of which use purpose of communication is radar communication. The radar communication device 50 radiates (transmits) a signal and detects (receives) a signal rebounded by reflection of the radiated signal against an object. The radar communication device 50 measures a required time elapse from radiation of a signal until reception of its reflected signal, and calculates a distance to an object of the reflection on a basis of the measured required time elapse. When the radar communication device 50 radiates (transmits) a signal into a vehicle interior of the vehicle C1, the radar communication device 50 may be used as a device for monitoring presence, motions and the like of a crew. Meanwhile, when the radar communication device 50 radiates (transmits) a signal to vehicle exterior of the vehicle C1, the radar communication device 50 may be used as a device for monitoring presence, motions and the like of any obstacle located around the vehicle C1.

### 2. Determination of Preamble Type

### 2-1. Frame Format

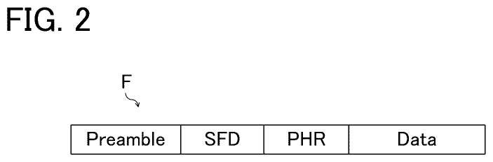

Here is described a format (hereinafter, referred to as frame format) of a communication frame (one unit of transmission data) of UWB communication with reference to FIG. 2. The frame format to be used in UWB communication is prescribed by the above-described communication standards.

As shown in FIG. 2, a frame format F to be used in UWB communication has a structure in which a leading preamble, an SFD (Start Frame Delimiter), a PHR (PHY Header), and a data body are arrayed together sequentially. It is noted that the data body is a wording employed for easier understanding of differences from the preamble, the SFD and the PHR.

The preamble is a bit string of a specified pattern, or a sequence constructed of pulses (e.g., −, 0, +) or the like, which is transmitted prior to the data body to make it known to the reception side by digital communication that “data is about to be sent”. The reception side is enabled to get start location (synchronization) of reception clocks by using a preamble signal. The preamble is given in plural types of patterns. That is, there are plural types of preambles.

As physical layer parameters of the preamble, preamble code and length of the preamble (preamble length) are settable.

As to types of preamble code, there are 24 types of codes 1 to 24. The codes 1 to 8 are codes of which PRF (Pulse Repetition Frequency) is 16 MHz. The codes 9 to 24 are codes of which PRF is 64 MHz.

The preamble length depends on a number of symbols contained in the preamble. The preamble length is selected from among such patterns as 16 symbols, 64 symbols, 128 symbols, 256 symbols, 512 symbols, 1024 symbols, 2048 symbols, and 4096 symbols.

The preamble is a bit string of a predetermined pattern such as “10101010 . . . ” , or a sequence constructed of pulses (e.g., −, 0, +) or the like. The preamble length is a size (length) which becomes increasingly longer with increasing number of symbols contained in the preamble.

The SFD is a bit string of a specific pattern to make a sign for a start of data in the communication frame. The PHR includes information necessary for decoding of packets. For example, the PHR includes an address of a communication partner, information as to data length of data interlinked backward, and the like. The data body, being a body of information to be transmitted to the communication partner, includes actual data to be transmitted. For example, the data body includes information exemplified by ID information of a communication-frame reception partner, ID information of a transmission partner, instruction information for the slave communication devices 20 by the master communication device 10, sensor values detected by sensors provided in the slave communication devices 20, operating states of actuators to be controlled by the slave communication devices 20, and the like.

In this embodiment, the master communication device 10, the slave communication devices 20, the distance-measuring communication device 40, and the radar communication device 50 use preamble types, respectively, each of which is determined according to a use purpose of communication from among plural preamble types determined by pulse repetition frequencies of a preamble or lengths of a preamble. Since preamble types vary from superior to inferior in terms of resistance to radio interference, using a preamble type of superior resistance to radio interference as a preamble type to be used in communication with a high-priority use purpose makes it possible to improve the communication success rate in communication with a high-priority use purpose. Accordingly, the master communication device 10, the slave communication devices 20, the distance-measuring communication device 40, and the radar communication device 50 determine preamble types, respectively, on a basis of the degree of use-purpose priority, and each use the determined preamble type.

### 2-2. First Determination Example

As an example, the master communication device 10, the slave communication devices 20, the distance-measuring communication device 40, and the radar communication device 50 individually use a preamble type determined according to use purpose of communication from among a plurality of preamble types determined by pulse repetition frequencies of the preamble. Since preamble types vary from superior to inferior in terms of resistance to radio interference depending on the pulse repetition frequency of the preamble, setting the pulse repetition frequency of the preamble, which is used in communication with a high-priority use purpose, to a frequency superior in resistance to radio interference makes it possible to improve the communication success rate in communication with a high-priority use purpose.

More specifically, since the resistance to radio interference becomes higher and higher with heightening pulse repetition frequency of the preamble, setting the pulse repetition frequency of the preamble, which is used in communication with a high-priority use purpose, to a higher frequency makes it possible to improve the communication success rate in communication with a high-priority use purpose. Such a correlation between the pulse repetition frequency of the preamble and the resistance to radio interference can be attributed to a cause that preambles of higher pulse repetition frequencies are analyzed preferentially in receiver part of communication devices.

Therefore, in a case where a first use purpose is given priority to (more importance than) a second use purpose and moreover the first use purpose is employed as a use purpose of communication, the pulse repetition frequency determined in this case is preferably set to a pulse repetition frequency higher than a pulse repetition frequency determined when the second use purpose is employed as a use purpose of communication. Similarly, in another case where the first use purpose is given priority to a third use purpose and moreover the first use purpose is employed as a use purpose of communication, the pulse repetition frequency determined in this case is preferably set higher than a pulse repetition frequency determined when the third use purpose is employed as a use purpose of communication.

In the first determination example, the preamble length is preferably set to a singular length irrespective of use purpose of communication.

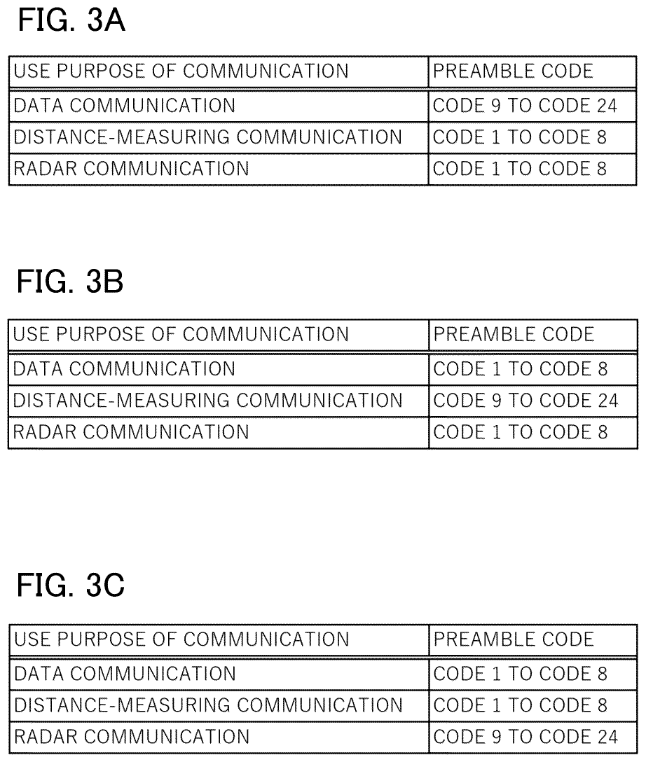

FIG. 3A is a chart showing a first determination pattern included in the first determination example. The first determination pattern is a determination pattern in which the first use purpose is data communication, the second use purpose is one of distance-measuring communication and radar communication, and the third use purpose is the other of distance-measuring communication and radar communication.

When the master communication device 10, the slave communication devices 20, the distance-measuring communication device 40, and the radar communication device 50 have determined preamble types, respectively, according to the first determination pattern, preamble codes of preambles to be used in communications performed by the master communication device 10 and the slave communication devices 20, respectively, are set to any one of codes 9 to 24, so that pulse repetition frequencies of preambles to be used in communications performed by the master communication device 10 and the slave communication devices 20, respectively, are set to 64 MHz. Also when the master communication device 10, the slave communication devices 20, the distance-measuring communication device 40, and the radar communication device 50 have determined preamble types, respectively, according to the first determination pattern, preamble codes of preambles to be used in communications performed by the distance-measuring communication device 40 and the radar communication device 50, respectively, are set to any one of codes 1 to 8, so that pulse repetition frequencies of preambles to be used in communications performed by the distance-measuring communication device 40 and the radar communication device 50, respectively, are set to 16 MHz.

FIG. 3B is a chart showing a second determination pattern included in the first determination example. The second determination pattern is a determination pattern in which the first use purpose is distance-measuring communication, the second use purpose is one of data communication and radar communication, and the third use purpose is the other of data communication and radar communication.

When the master communication device 10, the slave communication devices 20, the distance-measuring communication device 40, and the radar communication device 50 have determined preamble types, respectively, according to the second determination pattern, a preamble code of a preamble to be used in communication performed by the distance-measuring communication device 40 is set to any one of codes 9 to 24, so that a pulse repetition frequency of the preamble to be used in communication performed by the distance-measuring communication device 40 is set to 64 MHz. Also when the master communication device 10, the slave communication devices 20, the distance-measuring communication device 40, and the radar communication device 50 have determined their preamble types, respectively, according to the second determination pattern, preamble codes of preambles to be used in communications performed by the master communication device 10, the slave communication devices 20, and the radar communication device 50, respectively, are set to any one of codes 1 to 8, so that pulse repetition frequencies of preambles to be used in communications performed by the master communication device 10, the slave communication devices 20, and the radar communication device 50, respectively, are set to 16 MHz.

FIG. 3C is a chart showing a third determination pattern included in the first determination example. The third determination pattern is a determination pattern in which the first use purpose is radar communication, the second use purpose is one of data communication and distance-measuring communication, and the third use purpose is the other of data communication and distance-measuring communication.

When the master communication device 10, the slave communication devices 20, the distance-measuring communication device 40, and the radar communication device 50 have determined preamble types, respectively, according to the third determination pattern, a preamble code of a preamble to be used in communication performed by the radar communication device 50 is set to any one of codes 9 to 24, so that a pulse repetition frequency of a preamble to be used in communication performed by the radar communication device 50 is set to 64 MHz. Also when the master communication device 10, the slave communication devices 20, the distance-measuring communication device 40, and the radar communication device 50 have determined preamble types, respectively, according to the third determination pattern, preamble codes of preambles to be used in communications performed by the master communication device 10, the slave communication devices 20, and the distance-measuring communication device 40, respectively, are set to any one of codes 1 to 8, so that pulse repetition frequencies of preambles to be used in communications performed by the master communication device 10, the slave communication devices 20, and the distance-measuring communication device 40, respectively, are set to 16 MHz.

In the first determination example, the second use purpose and the third use purpose are of the same preamble type. That is, in the first determination example, even with different use purposes of communication, it is permitted that one identical preamble type is determined for those use purposes. This feature leads to an increase of preamble types that are permitted for use with the second use purpose and the third use purpose, allowing a degree of freedom for setting of preamble types to be increased.

### 2-3. Second Determination Example

As an example, the master communication device 10, the slave communication devices 20, the distance-measuring communication device 40, and the radar communication device 50 use preamble types, respectively, each of which is determined according to a use purpose of communication from among plural preamble types defined by the length of the preamble. Since preamble types vary from superior to inferior in terms of resistance to radio interference depending on the preamble length, setting the preamble length, which is used for communication with a high-priority use purpose, to a length superior in resistance to radio interference makes it possible to improve the communication success rate in communication with a high-priority use purpose.

More specifically, since the resistance to radio interference becomes higher and higher with increasing length of the preamble, setting the length of the preamble, which is to be used in communication with a high-priority use purpose, to a longer length makes it possible to improve the communication success rate in communication with a high-priority use purpose.

Therefore, in a case where a first use purpose is given priority to (more importance than) a second use purpose and moreover the first use purpose is used as a use purpose of communication, the preamble length determined in this case is preferably set longer than a preamble length determined when the second use purpose is used as a use purpose of communication. Similarly, in another case where the first use purpose is given priority to a third use purpose and moreover the first use purpose is used as a use purpose of communication, the preamble length determined in this case is preferably set longer than a preamble length determined when the third use purpose is used as a use purpose of communication.

In the second determination example, the pulse repetition frequency of the preamble is preferably set to a singular frequency irrespective of use purpose of communication.

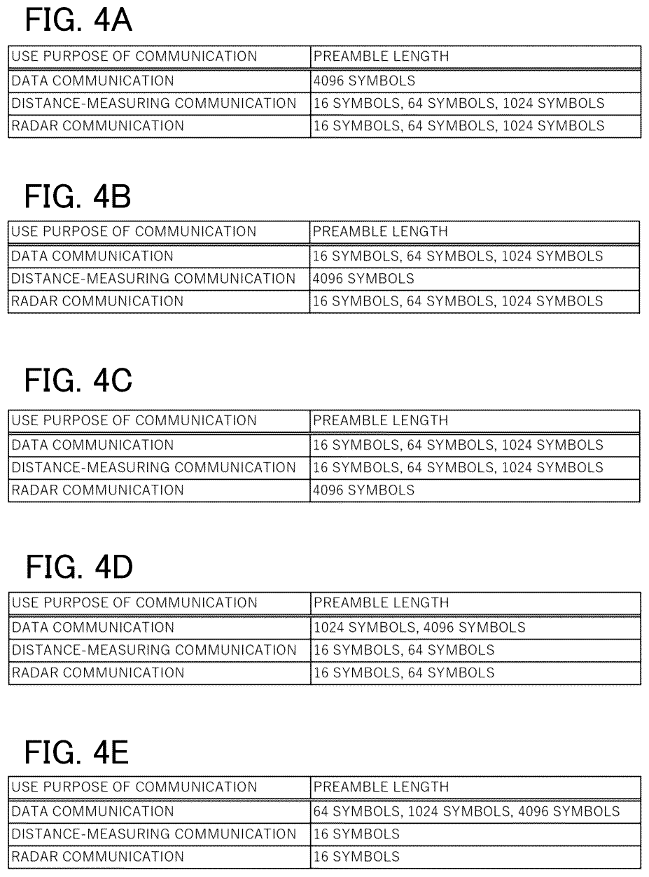

FIG. 4A is a chart showing a fourth determination pattern included in the second determination example. The fourth determination pattern is a determination pattern in which the first use purpose is data communication, the second use purpose is one of distance-measuring communication and radar communication, and the third use purpose is the other of distance-measuring communication and radar communication.

When the master communication device 10, the slave communication devices 20, the distance-measuring communication device 40, and the radar communication device 50 have determined preamble types, respectively, according to the fourth determination pattern, lengths of preambles to be used in communications performed by the master communication device 10 and the slave communication devices 20, respectively, are set to 4096 symbols. Also when the master communication device 10, the slave communication devices 20, the distance-measuring communication device 40, and the radar communication device 50 have determined preamble types, respectively, according to the fourth determination pattern, lengths of preambles to be used in communications performed by the distance-measuring communication device 40 and the radar communication device 50, respectively, are set to any one of 16 symbols, 64 symbols, and the 1024 symbols.

FIG. 4B is a chart showing a fifth determination pattern included in the second determination example. The fifth determination pattern is a determination pattern in which the first use purpose is distance-measuring communication, the second use purpose is one of data communication and radar communication, and the third use purpose is the other of data communication and radar communication.

When the master communication device 10, the slave communication devices 20, the distance-measuring communication device 40, and the radar communication device 50 have determined preamble types, respectively, according to the fifth determination pattern, a length of a preamble to be used in communication performed by the distance-measuring communication device 40 is set to 4096 symbols. Also when the master communication device 10, the slave communication devices 20, the distance-measuring communication device 40, and the radar communication device 50 have determined preamble types, respectively, according to the fifth determination pattern, lengths of preambles to be used in communications performed by the master communication device 10, the slave communication devices 20, and the radar communication device 50, respectively, are set to any one of 16 symbols, 64 symbols, and 1024 symbols.

FIG. 4C is a chart showing a sixth determination pattern included in the second determination example. The sixth determination pattern is a determination pattern in which the first use purpose is radar communication, the second use purpose is one of data communication and distance-measuring communication, and the third use purpose is the other of data communication and distance-measuring communication.

When the master communication device 10, the slave communication devices 20, the distance-measuring communication device 40, and the radar communication device 50 have determined preamble types, respectively, according to the sixth determination pattern, a length of a preamble to be used in communication performed by the radar communication device 50 is set to 4096 symbols. Also when the master communication device 10, the slave communication devices 20, the distance-measuring communication device 40, and the radar communication device 50 have determined preamble types, respectively, according to the sixth determination pattern, lengths of preambles to be used in communications performed by the master communication device 10, the slave communication devices 20, and the distance-measuring communication device 40, respectively, are set to any one of 16 symbols, 64 symbols, and 1024 symbols.

In the above-described fourth to sixth determination patterns, a preamble length corresponding to a high-priority use purpose is 4096 symbols, and preamble lengths corresponding to the other use purposes are 16 symbols, 64 symbols, and 1024 symbols, whichever it is any one of these. However, these patterns are not limitative, and like a modification example of the fourth determination pattern shown in FIG. 4D, a preamble length corresponding to a high-priority use purpose may be any one of 1024 symbols and 4096 symbols while a preamble length corresponding to other use purposes may be any one of 16 symbols and 64 symbols. Also, like another modification example of the fourth determination pattern shown in FIG. 4E, a preamble length corresponding to a high-priority use purpose may be any one of 64 symbols, 1024 symbols, and 4096 symbols while a preamble length corresponding to other use purposes may be 16 symbols.

In the second determination example, the preamble type differs in terms of the second use purpose. Similarly, in the second determination example, the preamble type differs in terms of the third use purpose. That is, in the second determination example, it is permitted that different preamble types may be set even for an identical use purpose of communication. As a result, even with an identical use purpose of communication, preamble types can be subdivided depending on elements (e.g., data type, partner-side device type of a distance-measuring target, obstacle type (vehicle-interior obstacles, vehicle-exterior obstacles, etc.) other than the use purpose, contributing to an increase of the degree of freedom for preamble type setting.

### 2-4. Third Determination Example

As an example, the master communication device 10, the slave communication devices 20, the distance-measuring communication device 40, and the radar communication device 50 each use a preamble type determined according to a use purpose of communication from among a plurality of preamble types defined by the pulse repetition frequency of the preamble and the preamble length. Since preamble types vary from superior to inferior in terms of resistance to radio interference depending on the pulse repetition frequency of the preamble as well as on the preamble length, setting the pulse repetition frequency of the preamble, which is used in communication with a high-priority use purpose, to a frequency superior in resistance to radio interference, and moreover setting the preamble length to be used in communication with a high-priority use purpose to a length superior in terms of resistance to radio interference, makes it possible to improve the communication success rate in communication with a high-priority use purpose.

More specifically, since the resistance to radio interference becomes higher and higher with heightening pulse repetition frequency of the preamble, the pulse repetition frequency of the preamble, which is to be used in communication with a high-priority use purpose, is set to a higher frequency, and since the resistance to radio interference becomes higher and higher with increasing preamble length, the length of the preamble to be used in communication with a high-priority use purpose is set to a longer length. As a result of this, it becomes possible to improve the communication success rate in communication with a high-priority use purpose.

Therefore, in a case where a first use purpose is given priority to (more importance than) a second use purpose and moreover the first use purpose is employed as a use purpose of communication, the pulse repetition frequency determined in this case is preferably set higher than a pulse repetition frequency determined when the second use purpose is employed as a use purpose of communication. Furthermore, in a case where the first use purpose is employed as a use purpose of communication, the preamble length determined in this case is preferably set longer than a preamble length determined when the second use purpose is employed as a use purpose of communication. Similarly, in another case where the first use purpose is given priority to a third use purpose and moreover the first use purpose is employed as a use purpose of communication, the pulse repetition frequency determined in this case is preferably set higher than a pulse repetition frequency determined when the third use purpose is employed as a use purpose of communication. Furthermore, in a case where the first use purpose is employed as a use purpose of communication, the preamble length determined when the first use purpose is employed as a use purpose of communication is preferably set longer than the preamble length determined when the third use purpose is employed as a use purpose of communication.

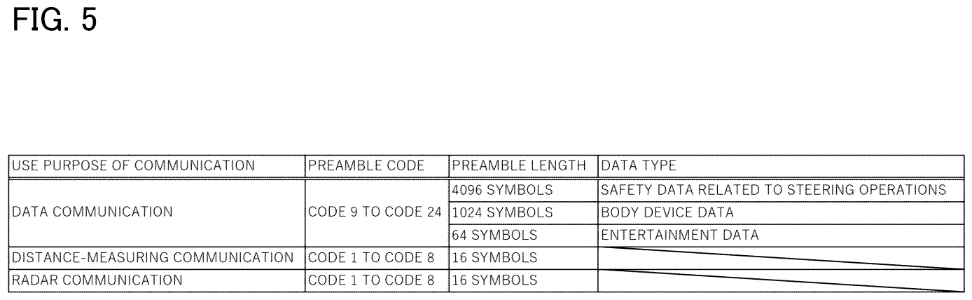

FIG. 5 is a chart showing a seventh determination pattern included in the third determination example. The seventh determination pattern is a determination pattern in which the first use purpose is data communication, the second use purpose is one of distance-measuring communication and radar communication, and the third use purpose is the other of distance-measuring communication and radar communication.

When the master communication device 10, the slave communication devices 20, the distance-measuring communication device 40, and the radar communication device 50 have determined preamble types, respectively, according to the seventh determination pattern, a preamble code of a preamble to be used in communications performed by the master communication device 10 and the slave communication devices 20 is set to any one of codes 9 to 24, so that a pulse repetition frequency of a preamble to be used in communications performed by the master communication device 10 and the slave communication devices 20, respectively, is set to 64 MHz. Also when the master communication device 10, the slave communication devices 20, the distance-measuring communication device 40, and the radar communication device 50 have determined preamble types, respectively, according to the seventh determination pattern, the length of the preamble to be used in communications performed by the master communication device 10 and the slave communication devices 20, respectively, is set to any one of 64 symbols, 1024 symbols, and 4096 symbols. Furthermore, when the master communication device 10, the slave communication devices 20, the distance-measuring communication device 40, and the radar communication device 50 have determined preamble types, respectively, according to the seventh determination pattern, preamble codes of preambles to be used in communications performed by the distance-measuring communication device 40 and the radar communication device 50, respectively, are set to any one of codes 1 to 8, so that pulse repetition frequencies of preambles to be used in communications performed by the distance-measuring communication device 40 and the radar communication device 50, respectively, are set to 16 MHz. Moreover, when the master communication device 10, the slave communication devices 20, the distance-measuring communication device 40, and the radar communication device 50 have determined preamble types, respectively, according to the seventh determination pattern, lengths of the preamble to be used in communications performed by the distance-measuring communication device 40 and the radar communication device 50, respectively, are set to 16 symbols.

In the seventh determination pattern, preamble-length types are subdivided depending on data type in the first use purpose. In a case where communications are performed with “safety data related to steering operations,” which are the highest in priority in the field of data communication, the preamble length is set to 4096 symbols in order to enhance the resistance to radio interference. In another case where communications are performed with “body device data (such as wipers etc.),” which are the second highest in priority in data communication, the preamble length is set to 1096 symbols, and in still another case where communications are performed with “entertainment data (such as audio contents, video contents, etc.),” which are the lowest in priority in data communication, the preamble length is set to 64 symbols.

### 2-5. Modifications

Unlike this embodiment, it may also be configured that the distance-measuring communication device 40, immediately after start-up, operates as a slave communication device 20 to perform data communication with the master communication device 10, and upon receiving from the master communication device 10 an instruction for switching the use purpose of communication from data communication to distance-measuring communication by data communication with the master communication device 10, the distance-measuring communication device 40 switches the use purpose of communication from data communication to distance-measuring communication. The distance-measuring communication device 40 of such a configuration as described above is required only to include a storage unit for storing a data table showing correspondence between use purposes of communication and preamble types to be used in communication as an example, and a status-quo setting of at least one of a use purposes of communication and a preamble type, under which condition the distance-measuring communication device 40 may appropriately switch the preamble type to be used in communication in response to a use purpose of communication. With such a configuration that allows the preamble type for use in communication to be switched in response to a use purpose of communication, the preamble to be used in communication can be set appropriately in response to a use purpose of communication even when switching of the use purpose of communication is involved.

Similarly, unlike this embodiment, it may also be configured that the radar communication device 50, immediately after start-up, operates as a slave communication device 20 to perform data communication with the master communication device 10, and upon receiving from the master communication device 10 an instruction for switching the use purpose of communication from data communication to radar communication by data communication with the master communication device 10, the radar communication device 50 switches the use purpose of communication from data communication to radar communication. The radar communication device 50 of such a configuration as described above is required only to include a storage unit for storing a data table showing correspondence between use purposes of communication and preamble types to be used in communication as an example, and a status-quo setting of at least one of a use purpose of communication and a preamble type, under which condition the radar communication device 50 may appropriately switch the preamble type to be used in communication in response to a use purpose of communication. With such a configuration that allows the preamble type for use in communication to be switched in response to a use purpose of communication, the preamble to be used in communication can be set appropriately in response to a use purpose of communication even when switching of the use purpose of communication is involved.

### 3. Mask Mode

The master communication device 10 and the slave communication devices 20 in the communication system SYS1 may also be so configured as to be enabled to select a mask mode. Practicalization in combination of the above-described preamble determination and the mask mode makes it possible to further improve the communication success rate in communication with a high-priority use purpose.

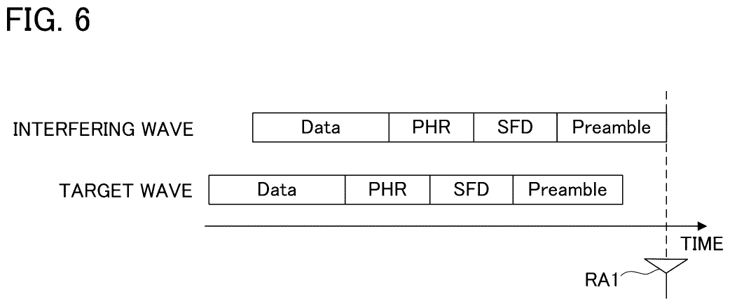

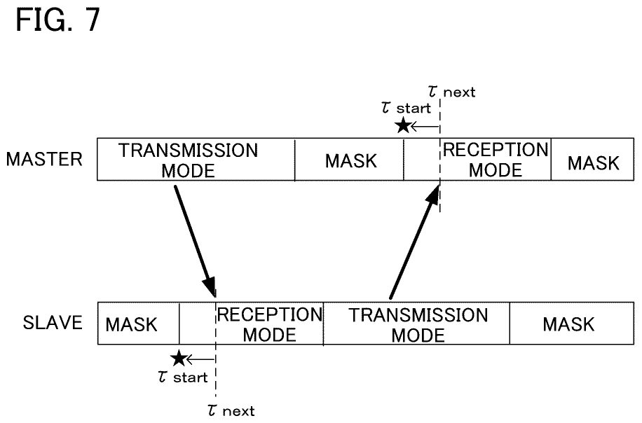

Here is described an outline of radio interference countermeasures in the communication system SYS1 with reference to FIGS. 6 and 7. FIG. 6 is a schematic chart for explaining problems under a reception condition of UWB communication. FIG. 7 is a schematic chart showing an outline of radio interference countermeasures in the communication system SYS1. It is noted that in FIG. 7, the term ‘master’ refers to the master communication device 10, and the term ‘slave’ refers to the slave communication device 20. In other figures also, similar abbreviated expressions may be used.

Referring to FIG. 6, a target wave is a wave which is desired for reception by a receiving antenna RA1. An interfering wave is a wave which is undesired for reception by the receiving antenna RA1. In UWB communication, although intensity or weakness of radio waves is also rather influential, an earlier-received wave, basically, is preferentially processed. More specifically, the communication device enters synchronization process of the preceding wave while disabled from processing the succeeding wave. In FIG. 6, two waves of the interfering wave and the target wave, in this order, reach the receiving antenna RA1. Thus, the interfering wave is preferentially processed. The reception-side device, when having received the interfering wave earlier, cannot recognize the wave's being an interfering wave without demodulating an address included in the PHR which is to be processed subsequent to the preamble and the SFD. In addition, once having recognized the wave's being an interfering wave, the reception-side device stops processing with the interfering wave, enabled to do with reception process of other waves (succeeding target wave etc.). There is a possibility that the target wave may reach the receiving antenna RA1 before a wave's being an interfering wave has been found by reception process, in which case mis-reception of the target wave may occur. In this embodiment, countermeasures for reducing such communication failures due to radio interference are provided. An outline of those countermeasures will be described with reference to FIG. 7.

As shown in FIG. 7, the master communication device 10 and the slave communication devices 20 are each enabled to select any one of the reception mode, the transmission mode, and the mask mode. In the reception mode, the individual devices 10 and 20 are reception-enabled. In the transmission mode, the individual devices 10 and 20 are transmission-enabled. In the mask mode, which is other than the reception mode and the transmission mode, the individual devices 10 and 20 are communication-disabled. In addition, the mask mode is a so-called idle mode that can be immediately moved to the reception mode or the transmission mode with power supplied to necessary circuits or the like.

Referring to FIG. 7, Istart represents a time point at which the communication devices 10 and 20 start the reception mode (reception-mode start time). Also, τₙₑₓₜ represents a time point at which reception of a target wave can be assumed (reception assumed time), the time point being compliant with arrangements made between the communication devices 10 and 20. The reception-mode start time τₛₜₐᵣₜ is set slightly before the reception assumed time τₙₑₓₜ. As shown in FIG. 7, the master communication device 10 switches from the mask mode to the reception mode immediately before the reception assumed time arranged with the slave communication devices 20. Each slave communication device 20 switches from the mask mode to the reception mode immediately before the reception assumed time arranged with the master communication device 10. That is, in a communication method using wireless communication of this embodiment, a switching from the mask mode, in which wireless communication is disabled, to the reception mode, in which reception of wireless communication is performed, is performed immediately before a reception assumed time arranged between a plurality of devices 10 and 20, which operate wireless communication. Also in a communication device using wireless communication of this embodiment, a switching from the mask mode to the reception mode is performed before a reception assumed time arranged in conjunction with other devices which operate wireless communication. Instead, the switching process immediately before the reception assumed time may also be executed when a switching from the transmission mode to the reception mode is performed.

According to the configuration described above, it becomes implementable to enhance a probability that a device for receiving a target wave is in the mask mode at an arrival of an interfering wave. That is, a probability of receiving an interfering wave can be reduced, so that the probability of properly receiving a target wave can be enhanced. As a result, the communication success rate of wireless communication can be improved. In addition, it is preferable that the reception-mode start time be set, as much as possible, to immediately before the reception assumed time of a target wave. A detailed example of this will be described later.

### 4. Master Communication Device

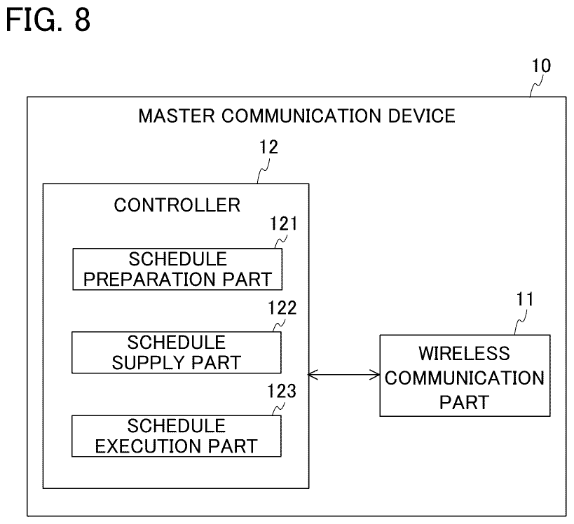

FIG. 8 is a diagram showing a configuration example of the master communication device 10. It is noted that FIG. 8 shows constituent elements necessary for explaining features of this embodiment with description of general constituent elements omitted.

As shown in FIG. 8, the master communication device 10 includes a wireless communication part 11 and a controller 12.

The wireless communication part 11 performs wireless communication with the slave communication devices 20. In more detail, the wireless communication part 11 is implemented by a UWB communication device which performs wireless communication with the slave communication devices 20. The wireless communication part 11 is reception-enabled in the reception mode, transmission-enabled in the transmission mode, and communication-disabled in the mask mode other than the reception mode and the transmission mode.

The controller 12 includes a processor for performing arithmetic processing and the like. The processor may be configured by including a CPU (Central Processing Unit) as an example. The controller 12 may be configured by one processor or by a plurality of processors. With the controller 12 configured by a plurality of processors, those processors may appropriately be connected so as to be communicatable to each other or one another. The controller 12 also includes computer-constituting components such as memory (RAM and ROM etc.) necessary for execution of programs.

The controller 12 functionally includes a schedule preparation part 121, a schedule supply part 122, and a schedule execution part 123. The individual functional parts 121 to 123 may be implemented, for example, by the processor executing arithmetic processes according to one program. However, without being limited to such a configuration, the functional parts 121 to 123 may be implemented, for example, by the processor executing arithmetic processes according to different programs for different functional parts, respectively.

Furthermore, the functional parts 121 to 123, although being implementable by instructing the processor to execute programs, i.e., by software as described above, may also be implemented by other techniques. At least some part of the functional parts 121 to 123 may be implemented, for example, by using ASIC (Application Specific Integrated Circuit), FPGA (Field Programmable Gate Array), or the like. That is, the functional parts 121 to 123 may be implemented by hardware with use of an exclusive IC or the like. The functional parts 121 to 123 may also be implemented by using software and hardware in combination. The functional parts 121 to 123 are conceptual constituent elements. A function to be executed by one constituent element may be distributed to a plurality of constituent elements. Moreover, functions of a plurality of constituent elements may also be integrated into one constituent element.

The schedule preparation part 121 prepares a schedule of UWB communication between the master communication device 10 and the slave communication devices 20 (hereinafter, referred to as wireless communication schedule). Included in the wireless communication schedule are timings of signal transmission and reception in the communication devices 10 and 20. In this embodiment, the slave communication devices 20 are provided in plurality. Therefore, the schedule preparation part 121 prepares a wireless communication schedule between the master communication device 10 and the individual slave communication devices 20a to 20d.

The schedule supply part 122 supplies the slave communication devices 20 with a wireless communication schedule prepared by the schedule preparation part 121. In this embodiment, the slave communication devices 20 are provided in plurality. Thus, the schedule supply part 122 transmits the wireless communication schedule to the individual slave communication devices 20a to 20d. Transmission of the wireless communication schedule to the slave communication devices 20a to 20d may be done separately for each of the slave communication devices 20a to 20d. However, in this embodiment, the schedule supply part 122 performs broadcast transmission in which the wireless communication schedule is transmitted simultaneously to a plurality of slave communication devices 20a to 20d.

The schedule execution part 123 executes wireless communication according to the wireless communication schedule prepared by the schedule preparation part 121. The schedule execution part 123 performs control of communication modes of the wireless communication part 11 for execution of wireless communication.

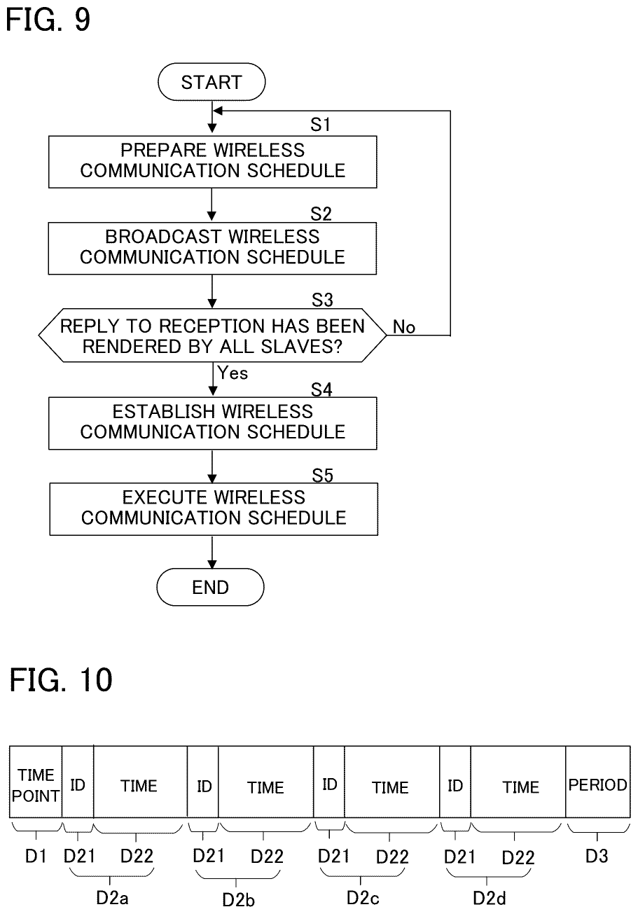

FIG. 9 is a flowchart showing an operation example of the master communication device 10. The operation shown in FIG. 9 is started, for example, at start-up of a body ECU that controls a vehicle C1's body installed in the vehicle C1. In more detail, the body ECU controls on-vehicle devices other than engine or other vehicle-running-system devices. The on-vehicle devices other than vehicle-running-system devices include, for example, air conditioners, door lock devices, window opening/closing devices, wiper devices, etc.

In addition, the start-up timing of the body ECU is typically exemplified by a timing at which a door lock of the vehicle C1 is released, and otherwise exemplified by an ACC-on time based on operation of a vehicle-ignition key or the like. In cases where the communication system is applied to other mobile objects (e.g., application to trains, ships, aircraft, etc.), a start timing of the operation shown in FIG. 9 is given by a timing of start-up operation of a mobile-object driving system, or the like. Also, the operation shown in FIG. 9 may be executed, after start-up of the body ECU, for example, as a regular operation (e.g., an operation executed immediately after start-up, operations executed at specified time intervals), or as an exceptional operation (e.g., operations in cases where a communication failure has occurred or communication failures have increased in number, or where a vehicle (communication) environment has changed). Also, at least one of the master communication device 10 and the slave communication devices 20a to 20d may be a body ECU, and not all of the master communication device 10 and the slave communication devices 20a to 20d may be body ECUs. The body ECU may be, for example, an entertainment device such as an audio device.

At step S1, the schedule preparation part 121 prepares a wireless communication schedule. The wireless communication schedule includes data transmission times from the master communication device 10 to the individual slave communication devices 20a to 20d, and data reception times of the master communication device 10 from the individual slave communication devices 20a to 20d. After the wireless communication schedule has been prepared, processing is moved on to next step S2. In addition, information related to wireless-communication connections of the slave communication devices 20a to 20d, which are target devices of wireless communication, has been set and registered (stored) in the master communication device 10 by an administrator of the master communication device 10 or the like. Further, when a new target device of wireless communication is to be added, an additional device is set and registered (stored) by the administrator or the like.

At step S2, the schedule supply part 122 broadcasts (simultaneously transmits) the wireless communication schedule toward all the slave communication devices 20a to 20d. That is, in this embodiment, the communication system SYS1 (vehicle-destined communication system), at a use-start of the vehicle, arranges a reception assumed time between the master communication device 10 and the slave communication devices 20. Transmission of the wireless communication schedule is done by broadcast in compliance with the above-described communication frame format (see FIG. 2) of UWB communication. The wireless communication schedule is included in the data body of the communication frame format.

FIG. 10 is a chart showing a data format example of the wireless communication schedule. As shown in FIG. 10, the data format of the wireless communication schedule has a structure in which time-point data D1, first data D2a, second data D2b, third data D2c, fourth data D2d, and period data D3 are sequentially arrayed.

The time-point data D1 is data indicative of a time point when broadcast transmission has actually been executed (hereinafter, referred to as broadcast transmission time). The broadcast transmission time is measured by the controller 12 on a basis of a timer (not shown) contained in the master communication device 10. It is noted that the timer is given by a counter or the like which counts with constant time intervals based on an operating clock.

The first data D2a is data related to the first slave communication device 20a. The second data D2b is data related to the second slave communication device 20b. The third data D2c is data related to the third slave communication device 20c. The fourth data D2d is data related to the fourth slave communication device 20d.

Each data D2a to D2d has a structure in which ID data D21 and time data D22 are sequentially arrayed. The ID data D21 is data indicative of ID (identification information) of the individual slave communication devices 20a to 20d. The time data D22 is data expressed by time intervals on a basis of broadcast transmission time or the like, while also serving as data related to data transmission time from the master communication device 10 as well as data reception time of the master communication device 10. The above-described transmission time and reception time are expressed by, for example, a form of what ms later since a broadcast transmission time. The reason that transmission time or reception time is not transmitted as a time point is that recognized time may differ among the individual communication devices 10 and 20a to 20d.

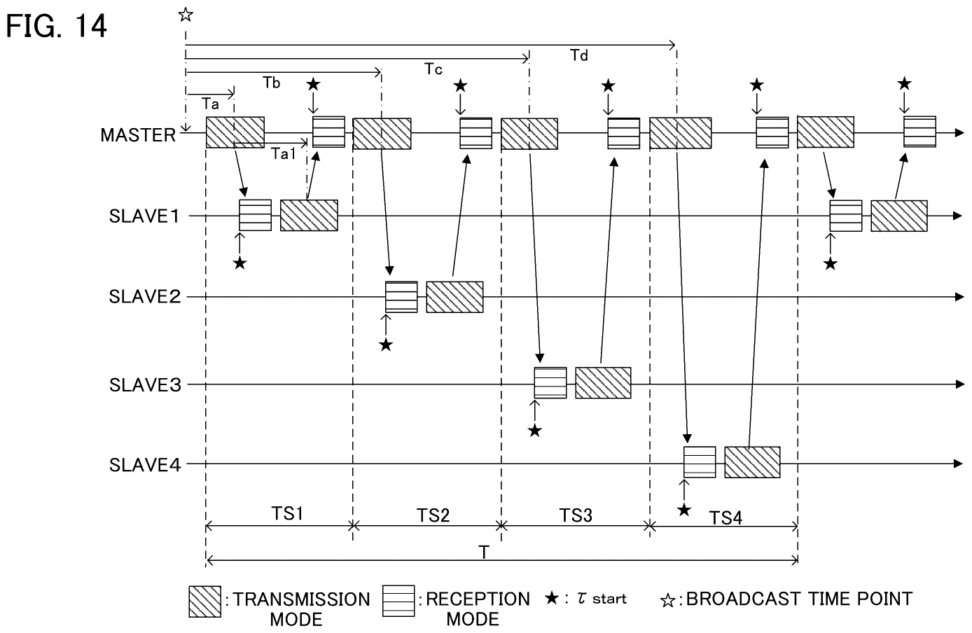

The period data D3 is data indicative of a period of communication timings between the master communication device 10 and the slave communication devices 20a to 20d (see, e.g., period T shown in FIG. 14).

Reverting to FIG. 9, when the wireless communication schedule has been broadcast, the processing is moved on to next step S3.

At step S3, the schedule supply part 122 decides whether or not all the slave communication devices 20a to 20d to which the wireless communication schedule had been transmitted have replied to their reception. The reply to their reception is a return transmission indicating their reception of the wireless communication schedule, while being a process that the slave communication devices 20a to 20d having received the wireless communication schedule are required. Since this requirement is included in the data of the above-described wireless communication schedule, each slave communication device 20 having received the wireless communication schedule has to make a return as far as being free from any failure. However, due to some reason such as occurrence of the above-described radio interference, it can occur that among the slave communication devices 20a to 20d is one that has failed to receive the wireless communication schedule. In particular, before broadcast transmission, the slave communication devices 20a to 20d, having no wireless communication schedule, are disabled to make a switching from the mask mode to the reception mode at a proper timing described above. Thus, there arises a need for keeping the reception mode active for a long time period, causing the slave communication devices 20a to 20d to be more likely affected by radio interference.

In a case where all the slave communication devices 20a to 20d have replied to their reception (Yes at step S3), the processing is moved on to next step S4. Meanwhile, in a case where at least one of all the slave communication devices 20a to 20d has not replied to their reception (No at step S3), the processing is returned to step S1. That is, the broadcast transmission of the wireless communication schedule is redone on condition that not all of the devices 20a to 20d, being targeted for broadcast transmission of the wireless communication schedule, have replied to their reception of the wireless communication schedule. With such a configuration, it can be prevented that the wireless communication schedule may be executed under a condition that the wireless communication schedule has not been transmitted properly from the master communication device 10 to the slave communication devices 20. In addition, on condition that rebroadcast transmission of the wireless communication schedule is executed at the period D3, reception-mode timings of the individual slave communication devices 20a to 20d by the wireless communication schedule in the rebroadcast transmission become equal thereamong resultantly. Therefore, without being limited to the case where all the slaves have replied to reception in the same broadcast transmission, it also becomes possible to set communication timings in conjunction with the slave communication devices 20a to 20d even when all the slaves have replied to reception in plural broadcast transmissions.

At step S4, the schedule supply part 122 establishes the wireless communication schedule. With the wireless communication schedule established, the processing is moved on to next step S5.

At step S5, the schedule execution part 123 starts a wireless communication process in compliance with the wireless communication schedule. Concrete examples of the wireless communication process in compliance with the wireless communication schedule will be described later.

With the configuration of this embodiment, for example, on condition that at least any one of the plural slave communication devices 20a to 20d has caused a failure, it results that the processing of step S3 remains far from ‘Yes’, with the wireless communication schedule continued to be unestablished for long. In view of such a problem, for example, it may be configured that an error is issued when the processing of step S3 has not reached ‘Yes’ even with the broadcast transmission executed to a specified number of times (e.g., three times). Also, as another example, it may be configured that a wireless communication schedule with failure-occurring one of the slave communication devices 20a to 20d excluded is prepared and wireless communication process compliant with the wireless communication schedule is executed.

### 5. Slave Communication Device

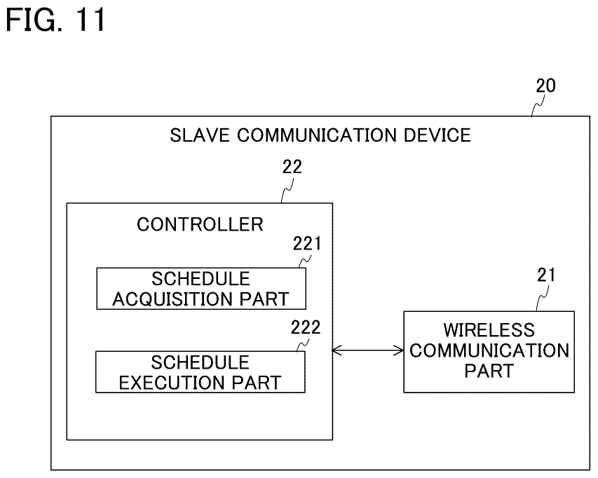

FIG. 11 is a diagram showing a configuration example of a slave communication device 20. It is noted that FIG. 11 shows constituent elements necessary for explaining features of this embodiment with description of general constituent elements omitted. Also, every one of the plural slave communication devices 20a to 20d has the configuration shown in FIG. 11. As shown in FIG. 11, the slave communication device 20 includes a wireless communication part 21 and a controller 22.

The wireless communication part 21 performs wireless communication in conjunction with the master communication device 10. More specifically, the wireless communication part 21 is implemented by a UWB communication device for performing UWB communication in conjunction with the master communication device 10 (wireless communication part 11). The wireless communication part 21 is reception-enabled in the reception mode, and transmission-enabled in the transmission mode, and communication-disabled in the mask mode other than the reception mode and the transmission mode.

The controller 22 includes a processor for performing arithmetic processing and the like. The processor may be configured by including a CPU as an example. The controller 22 may be configured by one processor or by a plurality of processors. With the controller 22 configured by a plurality of processors, those processors may appropriately be connected so as to be communicatable to each other or one another. The controller 22 also includes computer-constituting components such as memory (RAM and ROM etc.) necessary for execution of programs.

The controller 22 functionally includes a schedule acquisition part 221, and a schedule execution part 222. The individual functional parts 221 and 222 may be implemented, for example, by the processor executing arithmetic processes according to one program. However, without being limited to such a configuration, the functional parts 221 and 222 may be implemented, for example, by the processor executing arithmetic processes according to different programs for different functional parts, respectively.

Furthermore, the functional parts 221 and 222, although these may be implemented by instructing the processor to execute programs, i.e., by software as described above, may also be implemented by other techniques. At least some part of the functional parts 221 and 222 may be implemented, for example, by using ASIC, FPGA, or the like. That is, the functional parts 221 and 222 may be implemented by hardware with use of an exclusive IC or the like. The functional parts 221 and 222 may also be implemented by using software and hardware in combination. The functional parts 221 and 222 are conceptual constituent elements. A function to be executed by one constituent element may be distributed to a plurality of constituent elements. Moreover, functions of a plurality of constituent elements may also be integrated into one constituent element.

The schedule acquisition part 221 acquires a wireless communication schedule provided from the master communication device 10 via the wireless communication part 21. The schedule acquisition part 221 may execute processes necessary for the acquired wireless communication schedule from time to time. For example, as to time data included in the transmission data broadcast-transmitted from the master communication device 10, a process for converting the time data into a time point in the self device may be executed.

The schedule execution part 222 executes wireless communication according to the wireless communication schedule acquired by the schedule acquisition part 221. The schedule execution part 222 performs control of communication modes of the wireless communication part 21 for execution of wireless communication.

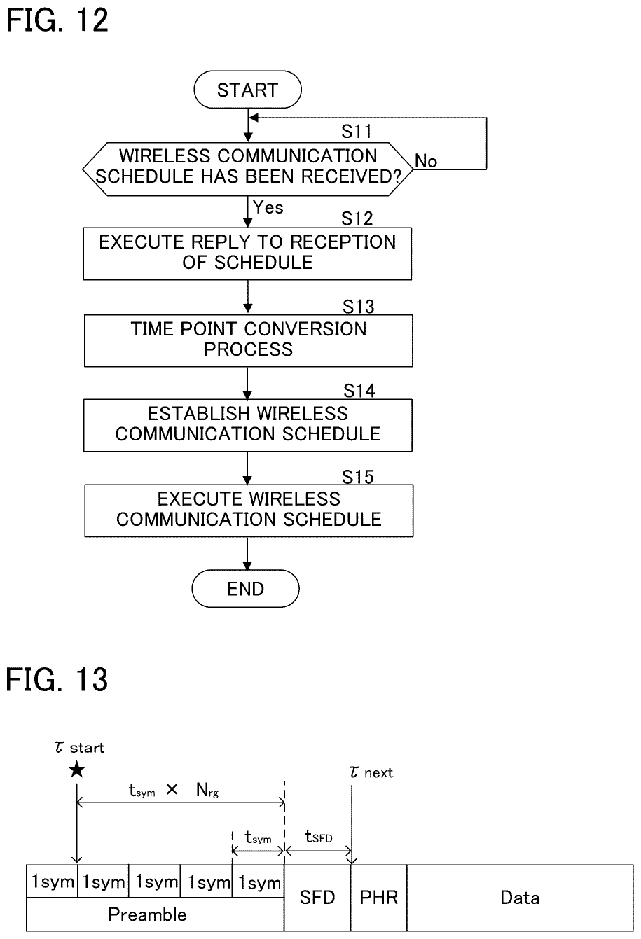

FIG. 12 is a flowchart showing an operation example of the slave communication device 20. In this embodiment, in which the slave communication devices 20 are provided in plurality, the individual slave communication devices 20a to 20d perform similar operations thereamong. Also, the operation shown in FIG. 12 is started coincidently with the above-described operation (see FIG. 9) of the master communication device 10. That is, the operation shown in FIG. 12 is started coincidently with, for example, start-up of the body ECU. Furthermore, the operation shown in FIG. 12 may be executed, for example, as a regular operation, or an exceptional operation, subsequent to the start-up of the body ECU.

At step S11, it is decided whether or not the schedule acquisition part 221 has received a wireless communication schedule. When the wireless communication schedule has been received (Yes at step S11), processing is moved on to next step S12. Meanwhile, when the wireless communication schedule has not been received (No at step S11), the process of step S11 is repeated. That is, at step S11, it is monitored whether or not a wireless communication schedule has been received.

At step S12, the schedule acquisition part 221 replies to reception of the wireless communication schedule. In more detail, in response to a return request from the master communication device 10 included in data having the wireless communication schedule included therein, the schedule acquisition part 221 returns a message of having received the wireless communication schedule. This return is executed by transmission using UWB communication from the slave communication devices 20 to the master communication device 10. Upon completion of reply to reception of the wireless communication schedule, the processing is moved on to next step S13.

At step S13, the schedule acquisition part 221 converts transmission time or reception time (e.g., time expressed as what ms later) on a basis of broadcast-transmission time or the like included in the wireless communication schedule, into a time point of the self device. The schedule acquisition part 221 performs time conversion process on a basis of a timer (not shown) contained in the self device. Upon completion of the time conversion process, the processing is moved on to next step S14.

At step S14, the schedule acquisition part 221 establishes the wireless communication schedule. In addition, the process of step S14 may be executed before the process of step S13. Upon establishment of the wireless communication schedule, the processing is moved on to next step S15.

At step S15, the schedule execution part 222 starts a wireless communication process compliant with the wireless communication schedule. A concrete example of the wireless communication process compliant with the wireless communication schedule will be described later.

### 6. Operation Example of Communication System Compliant with Wireless Communication Schedule

Next, an operation example of the communication system SYS1 compliant with the wireless communication schedule. In data communication process compliant with the wireless communication schedule, a reception-mode start time τₛₜₐᵣₜ in the master communication device 10 and the slave communication devices 20 is set to immediately before the reception assumed time τₙₑₓₜ as described above. It is noted that the reception-mode start time τₛₜₐᵣₜ is a time point when a switching from the mask mode to the reception mode is effected. Also, a switching process to the reception mode immediately before the reception assumed time τₙₑₓₜ may be executed also when the master communication device 10 receives a reply to reception from the slave communication device 20 after broadcast transmission.

The reception assumed time τₙₑₓₜ is calculated according to the wireless communication schedule broadcast-transmitted from any one of the plural devices 10 and 20a to 20d. In this embodiment, the wireless communication schedule is broadcast-transmitted from the master communication device 10 as described above. The reception assumed time τₙₑₓₜ is a time point derived from arrangement between the master communication device 10 and the slave communication devices 20a to 20d by the wireless communication schedule. With such a configuration, a correct reception timing compliant with the communication schedule can be obtained, allowing a proper start time of the reception mode to be fulfilled.

Preferably, the reception-mode start time τₛₜₐᵣₜ is executed immediately before the reception assumed time τₙₑₓₜ, as much as possible, so as to avoid interference of interfering waves. In this embodiment, the reception-mode start time τₛₜₐᵣₜ is configurationally set to a timing with considerations given to the above-described aspect. FIG. 13 is a schematic chart for explaining a detail example of a way of setting the reception-mode start time τₛₜₐᵣₜ.

Under a communication standard for UWB communication, transmission and reception times (time points) can be acquired at PHR timings. With considerations given to this aspect, in this embodiment, the reception assumed time τₙₑₓₜ is determined, as shown in FIG. 13, on a basis of PHR included in the frame format to be used in wireless communication. In this case, the reception-mode start time τₛₜₐᵣₜ can be set more easily to such a proper timing that allows interference probability of interfering waves to be reduced in UWB wireless communication. More specifically, the reception assumed time τₙₑₓₜ is set to the start timing of PHR.

In this embodiment, the reception-mode start time τₛₜₐᵣₜ, which is a time point immediately before the reception assumed time τₙₑₓₜ, is determined by the following Equation (1):

τₛₜₐᵣₜ=τₙₑₓₜ−(t_{SFD}+t_{sym}×N_{rg}) (1)

In Equation (1), the term ‘t_{SFD}’ is an SFD reception period (SFD time) included in the frame format. The term ‘t_{sym}’ is a 1-symbol reception period (1 symbol time) of the preamble code in the preamble included in the frame format. One symbol of the preamble code is, as described above, refers to a sequence symbol constructed by using pulses (e.g., −, 0, +) of a specified pattern. The term ‘N_{rg}’ is a necessary number of recognition times for 1 symbol of the preamble code. The communication devices 10 and 20 cannot receive transmission data of UWB communication until 1 symbol of the preamble code is recognized to the necessary number of recognition times N_{rg}. It is noted that the necessary number of recognition times N_{rg} is a number of times (device-dependent number of times) determined by the communication devices 10 and 20. In the case of FIG. 13, the necessary number of recognition times N_{rg} is four times as an example. Multiplying t_{sym} by the device-dependent necessary number of recognition times N_{rg} allows a least recognition period for the preamble to be calculated. In this embodiment, the reception-mode start time τₛₜₐᵣₜ is given as a time point which is earlier than the reception assumed time τₙₑₓₜ by a period obtained by an arithmetic expression (t_{SFD}+t_{sym}×N_{rg}).

Now that the reception-mode start time has been determined as described above, a start of the period in which reception of transmission data of UWB communication is enabled can be set to a time point close to the reception assumed time as much as possible. As a result, a likelihood of influences of interfering-wave interference can be reduced, so that the communication success rate can be improved. In addition, the reception-mode start time τₛₜₐᵣₜ may be set to a time point which is further earlier, by a margin time obtained by experiments or the like, than the reception assumed time τₙₑₓₜ by the period (time) obtained by the arithmetic expression (t_{SFD}+t_{sym}×N_{rg}).

FIG. 14 is a schematic chart showing an operation example of the communication system SYS1 according to a wireless communication schedule. The operation shown in FIG. 14 is an operation corresponding to execution of the wireless communication schedule at step S5 of FIG. 9 and step S15 of FIG. 12. In FIG. 14, the master communication device 10 and the slave communication devices 20a to 20d, while in neither the transmission mode nor the reception mode, are in the mask mode.

In addition, in FIG. 14, specified wireless communication is sequentially repeated at a period T between the master communication device 10 and each of the four slave communication devices 20a to 20d in compliance with the wireless communication schedule. However, this is only illustrative. Alternatively, specified wireless communication may be sequentially executed only once between the master communication device 10 and each of the four slave communication devices 20 in compliance with the wireless communication schedule. Also, the number of slave communication devices 20 that perform wireless communication periodically with the master communication device 10 may be changed as appropriate, and it may be configured that part of all the slave communication devices 20a to 20d included in the communication system SYS1 perform wireless communication periodically with the master communication device 10.

In the example shown in FIG. 14, the master communication device 10 first starts the transmission mode in compliance with the wireless communication schedule. Then, after a time elapse (transmission time Ta) arranged in conjunction with the first slave communication device 20a by the wireless communication schedule since the transmission time point of the above-described broadcast transmission, the master communication device 10 performs signal transmission toward the first slave communication device 20a. The signal in this transmission includes instruction information or the like for the first slave communication device 20a, as an example. In addition, the master communication device 10 completes the transmission mode at a timing which is determined by a time elapse (dependent on capacity of the transmission data etc.) necessary for data transmission on a basis of the start timing of the transmission mode and which has previously been programmed in the relevant device 10.

The first slave communication device 20a determines a reception-mode start time τₛₜₐᵣₜ by Equation (1) from the reception assumed time τₙₑₓₜ that depends on the above-described transmission time Ta arranged in conjunction with the first slave communication device 20a by the wireless communication schedule. Then, at the determined reception-mode start time τₛₜₐᵣₜ, the first slave communication device 20a performs a switching process from the mask mode to the reception mode. As a result, the first slave communication device 20a, while avoiding reception of interfering waves as much as possible, receives a transmission wave transmitted from the master communication device 10.

On a basis of the reception-mode start time τₛₜₐᵣₜ, and at timings previously programmed in the first slave communication device 20a, this device 20a sequentially executes an end of the reception mode, a start of the transmission mode, and an end of the transmission mode. After the start of the transmission mode, and when a time Ta1 arranged in conjunction with the master communication device 10 by the wireless communication schedule has elapsed since the above-described transmission timing (see transmission time Ta) of the master communication device 10, the first slave communication device 20a performs signal transmission toward the master communication device 10. The signal in this transmission contains, for example, sensor information or the like acquired by a sensor provided in the first slave communication device 20a. In addition, the first slave communication device 20a completes the transmission mode at a timing which is determined by a time elapse (dependent on capacity of the transmission data etc.) necessary for data transmission on a basis of the start timing of the transmission mode and which has previously been programmed in the relevant device 20a.

The master communication device 10 determines a reception-mode start time τₛₜₐᵣₜ by Equation (1) from a reception assumed time τₙₑₓₜ determined by the above-described time Ta1 arranged in conjunction with the first slave communication device 20a by the wireless communication schedule. Then, at the determined reception-mode start time τₛₜₐᵣₜ, the master communication device 10 performs a switching process from the mask mode to the reception mode. As a result, the master communication device 10, while avoiding reception of interfering waves as much as possible, receives a transmission wave transmitted from the first slave communication device 20a.

Through the above-described processes, communication between the master communication device 10 and the first slave communication device 20a, as defined by a first time slot TS1, is completed in the wireless communication schedule. Upon completion of the first time slot TS1, communication between the master communication device 10 and the second slave communication device 20b, as defined by a second time slot TS2, is executed by a procedure similar to that of the first time slot TS1. Also, upon completion of the second time slot TS2, communication between the master communication device 10 and the third slave communication device 20c, as defined by a third time slot TS3, is executed by a procedure similar to that of the first time slot TS1. Also, upon completion of the third time slot TS3, communication between the master communication device 10 and the fourth slave communication device 20d, as defined by a fourth time slot TS4, is executed by a procedure similar to that of the first time slot TS1. Upon completion of the fourth time slot TS4, one period T composed of the four time slots TS1 to TS4 is completed, followed by execution of a first time slot TS1 of a next period.

In addition, in the second time slot TS2, after an elapse of time (transmission time Tb) arranged in conjunction with the second slave communication device 20b since a transmission time point of broadcast transmission, the master communication device 10 executes signal transmission to the second slave communication device 20b. At a reception-mode start time τₛₜₐᵣₜ determined by the above-described transmission time Tb, the second slave communication device 20b performs a switching process from the mask mode to the reception mode. Further, after an elapse of a time Tb1 (not shown) arranged in conjunction with the master communication device 10 since the above-described transmission timing (see transmission time Tb) of the master communication device 10, the second slave communication device 20b having received a transmission wave from the master communication device 10 performs signal transmission to the master communication device 10. At the reception-mode start time τₛₜₐᵣₜ determined by the above-described time Tb1, the master communication device 10 performs a switching process from the mask mode to the reception mode.

Furthermore, in the third time slot TS3, after an elapse of time (transmission time Tc) arranged in conjunction with the third slave communication device 20c since the transmission time point of broadcast transmission, the master communication device 10 performs signal transmission to the third slave communication device 20c. At the reception-mode start time τₛₜₐᵣₜ determined by the above-described transmission time Tc, the third slave communication device 20c performs a switching process from the mask mode to the reception mode. Also, after an elapse of the time Tc1 (not shown) arranged in conjunction with the master communication device 10 since the above-described transmission timing (see transmission time Tc) of the master communication device 10, the third slave communication device 20c having received the transmission wave from the master communication device 10 performs signal transmission to the master communication device 10. At the reception-mode start time τₛₜₐᵣₜ determined by the above-described time Tc1, the master communication device 10 performs a switching process from the mask mode to the reception mode.

Also, in the fourth time slot TS4, after an elapse of time (transmission time Td) arranged in conjunction with the fourth slave communication device 20d since the transmission time point of broadcast transmission, the master communication device 10 performs signal transmission to the fourth slave communication device 20d. At the reception-mode start time τₛₜₐᵣₜ determined by the above-described transmission time Td, the fourth slave communication device 20d performs a switching process from the mask mode to the reception mode. Also, after an elapse of the time Td1 (not shown) arranged in conjunction with the master communication device 10 since the above-described transmission timing (see transmission time Td) of the master communication device 10, the fourth slave communication device 20d having received the transmission wave from the master communication device 10 performs signal transmission to the master communication device 10. At the reception-mode start time τₛₜₐᵣₜ determined by the above-described time Td1, the master communication device 10 performs a switching process from the mask mode to the reception mode.

As can be understood from the above description, in this embodiment, communications between the master communication device 10 and the slave communication devices 20a to 20d are performed at different timings, so that occurrence of radio interference can be avoided in these communications.

Also in this embodiment, the master communication device 10, after having performed broadcast transmission of the wireless communication schedule, performs signal reception subsequent to performing signal transmission by wireless communication in compliance with the wireless communication schedule. Then, during the reception to be performed subsequent to the transmission by wireless communication, a switching process to the reception mode is executed at the time point τₛₜₐᵣₜ determined by Equation (1). As a result, while reception of interfering waves are avoided as much as possible, signal reception can be fulfilled not only on the reception side of the wireless communication schedule but also on its transmission side.

In addition, in this embodiment, the master communication device 10 is so configured as to perform communications of signal transmission and signal reception, in this order, at the individual time slots TS1 to TS4. However, this is only illustrative and the master communication device 10 may perform communications in an order of signal reception and signal transmission at the individual time slots TS1 to TS4. In this case, at the individual time slots TS1 to TS4, the order of signal transmission and signal reception by the slave communication devices 20a to 20d needs to be reversed to that of this embodiment.

### 7. Modifications

### 7-1. First Modification

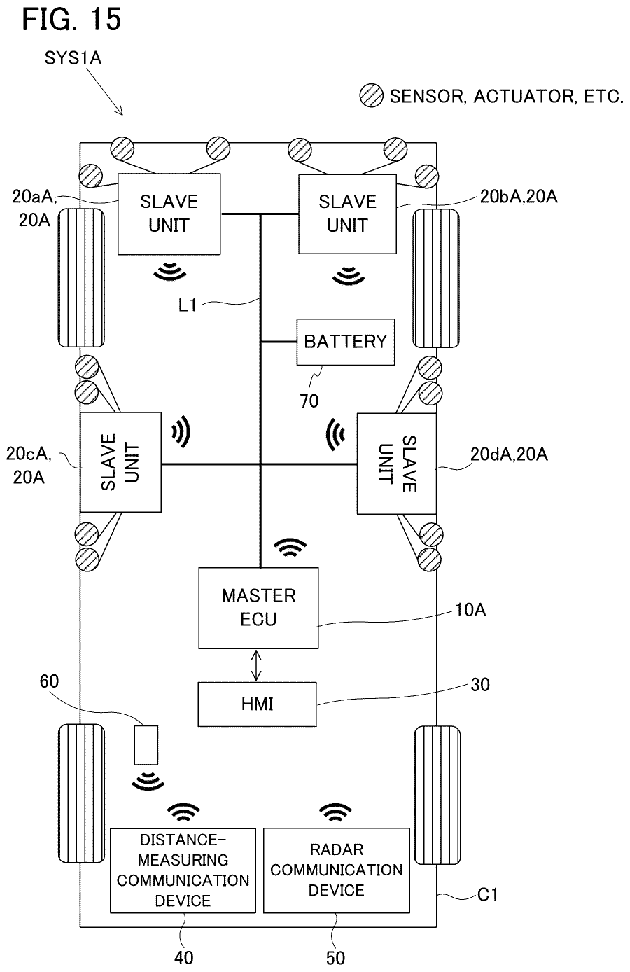

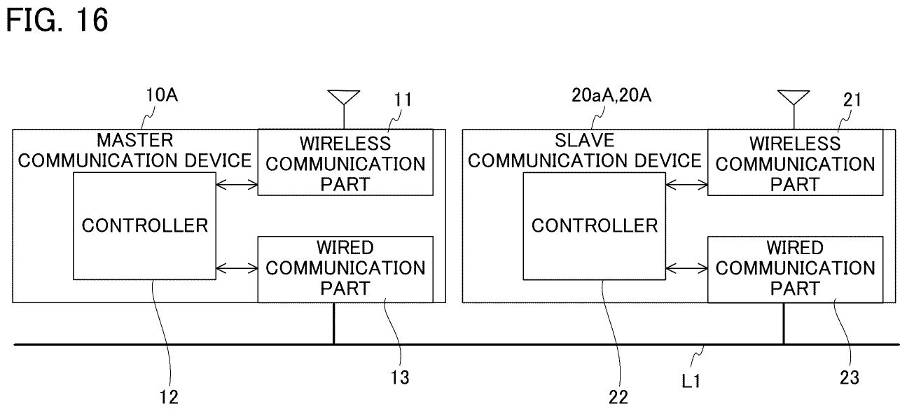

FIG. 15 is a view showing a configuration of a communication system SYS1A according to a first modification example. FIG. 16 is a diagram showing a relationship between a master communication device 10A and a slave communication device 20A included in the communication system SYS1A according to the first modification. In addition, in this modification also, the slave communication devices 20A are provided in plurality (specifically, four), where the individual slave communication devices 20aA, 20bA, 20cA, 20dA are communicatable with the master communication device 10A. Each of the slave communication devices 20aA to 20dA has a similar configuration. Therefore, in FIG. 16, only the first slave communication device 20aA is shown while the second slave communication device 20bA, the third slave communication device 20cA, and the fourth slave communication device 20dA are omitted in depiction.

Referring to FIGS. 15 and 16, bold line L1 represents communication line for use of wired communication. That is, in the communication system SYS1A of the first modification, the master communication device 10A and the slave communication device 20A are provided so as to be enabled to perform wired communication in addition to UWB communication as wireless communication. Therefore, as shown in FIG. 16, the master communication device 10A and the slave communication device 20A are equipped with wired communication parts 13, 23, respectively, for enabling wired communication in addition to the wireless communication parts 11, 21, respectively, for enabling UWB communication.

In this modification, the communication line L1 refers to a power supply line by which the master communication device 10A and the individual slave communication devices 20aA to 20dA are connected to a battery 70. That is, the wired communication to be performed between the master communication device 10A and the individual slave communication devices 20aA to 20dA is PLC (Power Line Communication) communication. In addition, without being limited to PLC, the wired communication to be used in the communication system SYS1A may be CAN (registered trademark, (Controller Area Network) communication, LIN (registered trademark, Local Interconnect Network) communication, CXPI (Clock Extension Peripheral Interface) communication, or the like.

In this modification, when the master communication device 10A executes broadcast transmission of the wireless communication schedule, wired communication is employed. That is, in this modification, broadcast transmission of the wireless communication schedule is executed by using wired communication (PLC communication) instead of UWB communication during the process shown in FIG. 9 described above.

Under a situation in which the wireless communication schedule has not been transmitted to the individual slave communication devices 20aA to 20dA, it is difficult to switch from the mask mode to the reception mode by focusing on a timing at which UWB communication is less affected by radio interference. This modification is so configured that wired communication is utilized instead of wireless communication under a situation in which UWB communication is highly likely to be affected by radio interference as described above. Accordingly, the possibility that communications may fail due to influence of radio interference during signal reception can be reduced. In addition, broadcast transmission of the wireless communication schedule may be executed by using both wireless communication and wired communication.

As described above, in this modification, wired communication is PLC communication using the power supply line L1. The power supply line L1 is a wire harness indispensable for power supply to the master communication device 10A and the slave communication devices 20aA to 20dA. That is, according to the configuration of this modification, since wired communication can be realized by exploiting irreducible wire harness, wired communication can be utilized while increases in wire harness are suppressed.

### 7-2. Second Modification

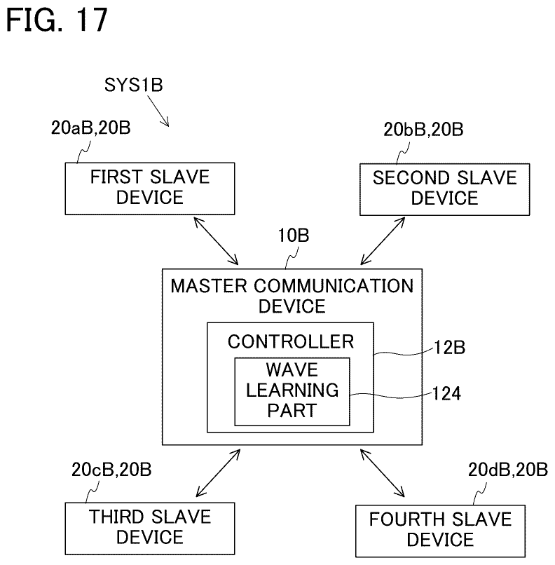

FIG. 17 is a diagram showing a configuration of a communication system SYS1B according to a second modification example. As shown in FIG. 17, the communication system SYS1B includes a master communication device 10B and a plurality of slave communication devices 20B, like the communication system SYS1 according to the above-described embodiment. The plurality of slave communication devices 20B include a first slave communication device 20aB, a second slave communication device 20bB, a third slave communication device 20cB, and a fourth slave communication device 20dB. Although the communication system SYS1B includes the distance-measuring communication device 40 and the radar communication device 50 like the communication system SYS1 according to the above-described embodiment, yet depiction of the distance-measuring communication device 40 and the radar communication device 50 is omitted in FIG. 17.

A controller 12B included in the master communication device 10B of this modification includes the functional parts 121 to 123 included in the controller 12 of the above-described embodiment, and additionally a wave learning part 124. The wave learning part 124 is a functional part which is fulfilled by execution of arithmetic processing according to programs by the processor included in the controller 12B, as an example. However, without being limited to a configuration fulfilled by software, the wave learning part 124 may also be fulfilled by hardware by using an exclusive IC or the like.

The wave learning part 124 determines an optimum value of wave output (performs calibration) in wireless communication (UWB communication) to be used between the master communication device 10B and the individual slave communication devices 20aB to 20dB. In this modification, the optimum value implies that the wave output is set to a necessary least output. Setting the wave output to a necessary least output makes it possible to reduce power consumption in the communication system SYS1B. Further, setting the wave output to a necessary least output makes it possible to lessen the likelihood of occurrence of interference with other communications.

In this modification, during the execution of the calibration for wave output by the wave learning part 124, UWB communication is performed between the master communication device 10B and the individual slave communication devices 20aB to 20dB. In this case, when the calibration of the wave output to be used between the devices is performed, a switching to the reception mode (switching from the mask mode) is executed immediately before the reception assumed time arranged between the devices.

In this case, calibration for wave output can be carried out while influences of radio interference are suppressed. That is, wireless communication to be performed for the calibration can be carried out while influences of radio interference are suppressed, so that the calibration for wave output can be accomplished promptly and precisely. In addition, the calibration for wave output may be performed also between devices other than those having a relationship of master and slave. Further, in this case also, a switching to the reception mode immediately before the reception assumed time arranged between devices may be done properly.

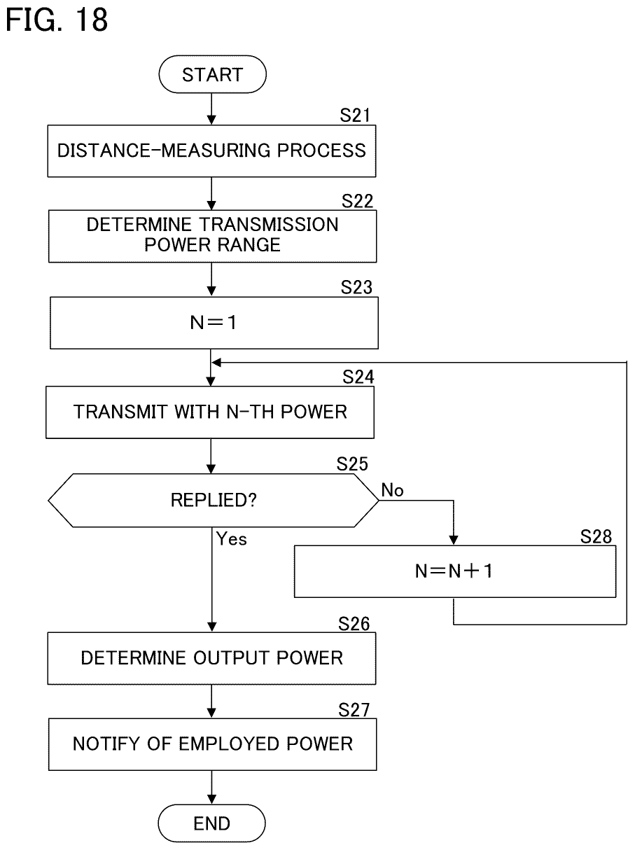

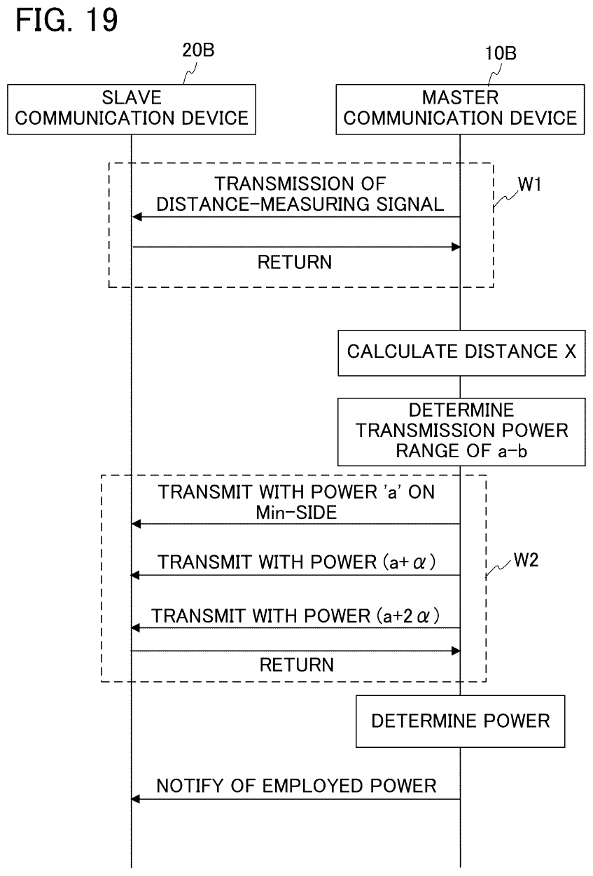

FIG. 18 is a flowchart showing one example of processing to be executed by the master communication device 10B (wave learning part 124) during a calibration for wave output. FIG. 19 is a chart for explaining operations of a slave communication device 20B during execution of the processing shown in FIG. 18.

The calibration for wave output (wave learning) is executed, for example, at a start of use of the communication system SYS1B. The calibration for wave output is started, for example, at the above-described start-up time of the body ECU. The calibration for wave output is executed, normally, before execution of broadcast transmission of the wireless communication schedule.

In addition, the calibration for wave output is performed between the master communication device 10B and the individual slave communication devices 20aB to 20dB, sequentially. Although the sequential order is not particularly limited, yet the master communication device 10B performs the calibration for wave output, for example, in an order of the first slave communication device 20aB, the second slave communication device 20bB, the third slave communication device 20cB, and the fourth slave communication device 20dB. During the execution of each calibration, the processes shown in FIGS. 18 and 19 are executed.

As shown in FIG. 18, at step S21, the master communication device 10B performs a distance-measuring process for determining a distance to the slave communication device 20B. The distance-measuring process may appropriately be done by using well-known process. In the distance-measuring process, the master communication device 10B transmits a distance-measuring signal to the slave communication device 20B by UWB communication. The slave communication device 20B renders a return in response to reception of the distance-measuring signal (see FIG. 19). Based on these signal-exchange processes, determining a time required for radio waves to move between the devices makes it possible to calculate a distance X between the master communication device 10B and the slave communication device 20B in view of the radio-wave velocity being already well known.

In addition, the wave output of UWB communication to be used for the distance-measuring process is preferably an approximate value close to a maximum power which is defined by communication standards (e.g., −41.3 dBm/MHz). The approximate value close to the maximum power is a value equal to a maximum power or a value slightly smaller than the maximum power. With the wave output in the distance-measuring process set to an approximate value close to the maximum power as shown above, the probability that waves may fail to reach each other between the master communication device 10B and the slave communication device 20B can be reduced, so that the success rate of the distance-measuring process can be enhanced.

Now that the distance X has been determined by the distance-measuring process, the master communication device 10B moves on the processing to step S22.

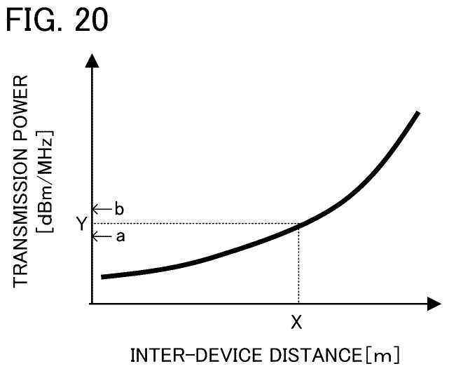

At step S22, the master communication device 10B determines a range (output range) of transmission power to be used for determination of an optimum value for wave output. For the determination of the transmission-power range, a previously prepared correlation map showing a relationship between inter-device distances and transmission powers (wave outputs). FIG. 20 is one example of the correlation map showing a relationship between inter-device distances and transmission powers. Although the correlation map is a map prepared based on experiments or the like, yet there is a possibility that a transmission power determined by the correlation map may not necessarily be an optimum value due to device-by-device characteristic variations, temperature or other environmental variations, and the like. For this reason, the calibration for determining an optimum value of wave output is executed.

From the distance X determined at step S21 and the correlation map (see FIG. 20), the master communication device 10B first determines a transmission power Y that is quite likely an electric power approximate to the optimum value. Then, the master communication device 10B determines a minimum value ‘a’ and a maximum value ‘b’ by referencing the determined transmission power Y as a criterion (see FIG. 20). The minimum value ‘a’ and the maximum value ‘b’ may be determined by using a previously prepared table or relational expression. Upon determination of the transmission power range, the master communication device 10B moves on the processing to step S23.

At step S23, the master communication device 10B sets a variable N to 1. With the variable N set to 1, the master communication device 10B moves on the processing to step S24.

At step S24, the master communication device 10B transmits a UWB wave to the slave communication device 20B with N-th power. The N-th power is determined in compliance with a previously set standard. In this modification, the N-th power is an electric power obtained by adding, to the minimum value ‘a’ of the transmission power range, a value resulting from multiplying a predetermined segmented electric power a by (N−1). That is, given N=1 (i.e., in a case of a first-time transmission for electric power adjustment) as an example, the N-th power comes to ‘a’. Also, given N=2 as an example, the N-th power comes to ‘a+α’. Also, given N=3 as an example, the N-th power comes to ‘a+2α’. In addition, although the above-described example is configured that transmission power is increased gradually on a basis of the minimum value ‘a’ of the transmission power range, yet this is only for illustration's sake; it may be configured that transmission power is decreased gradually on a basis of the maximum value ‘b’ of the transmission power range. Upon completion of the transmission with the N-th power, the master communication device 10B moves on the processing to step S25.

At step S25, the master communication device 10B decides whether or not the slave communication device 20B has rendered a return transmission within a specified time period determined by experiments or the like. The slave communication device 20B, upon receiving a transmission wave from the master communication device 10B, renders a return transmission therefor. However, given a small transmission power of the transmission wave transmitted from the master communication device 10B, the transmission wave may fail to reach the slave communication device 20B. In this case, the master communication device 10B receives no return transmission from the slave communication device 20B. In the example shown in FIG. 19, the first transmission power and the second transmission power are not received by the slave communication device 20B, with the result that the slave communication device 20B has rendered no return transmission. On the other hand, the third transmission power is received by the slave communication device 20B, with the result that the slave communication device 20B has rendered a return transmission.

Given a return transmission from the slave communication device 20B (Yes at step S25), the master communication device 10B moves on the processing to step S26. On the other hand, given no return transmission from the slave communication device 20B (No at step S25), the master communication device 10B moves on the processing to step S28.

At step S26, the master communication device 10B determines an output power for a transmission wave. For example, the master communication device 10B regards, as an output power, the N-th power that is an electric power under a condition that the return transmission has been rendered from the slave communication device 20B. As another example, the master communication device 10B regards, as an output power, a total power of adding a margin determined by experiments or the like to the N-th power. In the example shown in FIG. 19, the output power is a third power (a+2α) or an electric power resulting from adding a margin power to the third power (a+2α). Upon determination of the output power, the master communication device 10B moves on the processing to step S27.

At step S27, the master communication device 10B notifies, by UWB communication, the determined output power as an employed electric power to the slave communication device 20B. As a result, it becomes implementable to perform UWB communication by the determined output power in conjunction between the master communication device 10B and the slave communication device 20B.

At step S28, the master communication device 10B performs a process of adding 1 to the variable N. Upon completion of the process of adding 1 to the variable N, the master communication device 10B returns the processing to step S24. By doing so, the master communication device 10B is enabled to output transmission waves while varying the output power.

In this modification, it is configured that during execution of the calibration of wave output, which is operated as described above, a switching to the reception mode immediately before the reception assumed time τₙₑₓₜ is performed on occasions of the distance-measuring process indicated by a broken-line frame W1 as well as an output-power adjustment process indicated by a broken-line frame W2 in FIG. 19.

For example, before execution of transmission of a signal (distance-mastering signal) for the distance-measuring process, the master communication device 10B and the slave communication device 20B preliminarily perform arrangement related to a transmission time point. Although this arrangement may be executed by using UWB communication, yet the above-described PLC communication may also be employed. According to this arrangement, the reception-mode start time τₛₜₐᵣₜ by the above-described Equation (1) can be determined. For example, when radio transmission is applied from the master communication device 10B to the slave communication device 20B, and when radio transmission is applied from the slave communication device 20B to the master communication device 10B, the reception-side device performs a switching to the reception mode immediately before the reception assumed time. As a result of this, the possibility that the distance-measuring process may be affected by radio interference can be reduced, so that prompt, precise distance measurement can be achieved.

Also, for example, before execution of transmission of a signal for the output-power adjustment process, the master communication device 10B and the slave communication device 20B preliminarily perform arrangement related to a transmission time point. Although this arrangement may be executed by using UWB communication, yet the above-described PLC communication may appropriately be employed. According to this arrangement, the reception-mode start time τₛₜₐᵣₜ by the above-described Equation (1) can be determined. For example, when radio transmission is applied from the master communication device 10B to the slave communication device 20B, and when radio transmission is applied from the slave communication device 20B to the master communication device 10B, the reception-side device performs a switching to the reception mode immediately before the reception assumed time. As a result of this, the possibility that the output-power adjustment process may be affected by radio interference can be reduced, so that output power can be determined promptly and properly.

The distance-measuring process indicated by the broken-line frame W1 in FIG. 19 is a preprocessing prior to data communication to be performed between the master communication device 10B and the slave communication device 20B. Therefore, a use purpose of the master communication device 10B and the slave communication device 20B during execution of the distance-measuring process indicated by the broken-line frame W1 in FIG. 19 may be regarded as not distance-measuring communication but data communication. In addition, it is also allowable that a use purpose of the master communication device 10B and the slave communication device 20B during execution of the distance-measuring process indicated by the broken-line frame W1 in FIG. 19 is set to distance-measuring communication, and that, after the execution of the distance-measuring process indicated by the broken-line frame W1 in FIG. 19, the master communication device 10B and the slave communication device 20B may switch over the preamble type from a type corresponding to distance-measuring communication to another type corresponding to data communication.

### 8. Cautions and Others

Various technical features herein disclosed in the embodiments for carrying out the invention may be changed and modified in various ways without departing from the gist of the technical creation of the invention. Furthermore, a plurality of embodiments and modifications herein disclosed in the embodiments for carrying out the invention may be carried out in as many combinations thereamong as possible.

### LIST OF REFERENCE SIGNS

10, 10A, 10B . . . master communication device
20, 20A, 20B . . . slave communication device
20a, 20aA, 20aB . . . first slave communication device
20b, 20bA, 20bB . . . second slave communication device
20c, 20cA, 20cB . . . third slave communication device
20d, 20dA, 20dB . . . fourth slave communication device
40 . . . distance-measuring communication device
50 . . . radar communication device
SYS1, SYS1A, SYS1B . . . communication system

1. A communication method using a preamble between a first communication device and a second communication device, in which:
the first communication device
executes communication with the second communication device by using a preamble type of the preamble which is determined, according to a use purpose of communication, from among a plurality of preamble types that are defined depending on a pulse repetition frequency of the preamble or a length of the preamble.

2. The communication method as claimed in claim 1, wherein
a first use purpose is given higher priority than a second use purpose, and
the pulse repetition frequency determined under a condition that the first use purpose is a use purpose of the communication is higher than the pulse repetition frequency determined under a condition that the second use purpose is a use purpose of the communication.

3. The communication method as claimed in claim 1, wherein
a first use purpose is given higher priority than a second use purpose, and
a length of the preamble determined under a condition that the first use purpose is a use purpose of the communication is longer than a length of the preamble determined under a condition that the second use purpose is a use purpose of the communication.

4. The communication method as claimed in claim 1, wherein a pulse repetition frequency of the preamble to be used in the communication and a length of the preamble are determined according to a use purpose of the communication.

5. The communication method as claimed in claim 4, wherein
a first use purpose is given higher priority than a second use purpose, and
the pulse repetition frequency determined under a condition that the first use purpose is a use purpose of the communication is higher than the pulse repetition frequency determined under a condition that the second use purpose is a use purpose of the communication, and
a length of the preamble determined under a condition that the first use purpose is a use purpose of the communication is longer than a length of the preamble determined under a condition that the second use purpose is a use purpose of the communication.

6. The communication method as claimed in claim 5, wherein the first use purpose is data communication, and the second use purpose is a use purpose including at least either one of distance-measuring communication and radar communication.

7. The communication method as claimed in claim 1, wherein
the communication is wireless communication by using UWB communication method, and
a use purpose of the communication is a use purpose including at least any one of data communication, distance-measuring communication, and radar communication.

8. The communication method as claimed in claim 1, wherein the pulse repetition frequency is 16 MHz or 64 MHz.

9. The communication method as claimed in claim 1, wherein a length of the preamble is any one of 16 symbols, 64 symbols, 128 symbols, 256 symbols, 512 symbols, 1024 symbols, 2048 symbols, and 4096 symbols.

10. The communication method as claimed in claim 1, wherein a use purpose of the communication is switchable.

11. The communication method as claimed in claim 1, wherein a switching from a mask mode, in which wireless communication is disabled, to a reception mode, in which reception of the wireless communication is enabled, is executed immediately before a reception assumed time arranged between the first communication device and the second communication device.

12. A communication system comprising:
a first communication device; and
a second communication device, wherein
the first communication device
executes communication with the second communication device by using a preamble type which is determined, according to a use purpose of the communication, from among a plurality of preamble types that are defined depending on a pulse repetition frequency of a preamble or a length of the preamble.

13. The communication system as claimed in claim 12, wherein
the communication is wireless communication by using UWB communication method, and
a use purpose of the communication is a use purpose including at least any one of data communication, distance-measuring communication, and radar communication.

14. The communication system as claimed in claim 13, wherein the first communication device and the second communication device are mounted on a vehicle.

15. The communication method as claimed in claim 1, wherein the first communication device
determines a pulse repetition frequency of 64 MHz under a condition that a use purpose of communication is data communication,
determines the pulse repetition frequency of 16 MHz under a condition that the use purpose of the communication is distance-measuring communication or radar communication, and
performs UWB_communication with the second communication device by using the determined pulse repetition frequency.

16. The communication method as claimed in claim 1, wherein the first communication device
determines a preamble length of 4096 symbols under a condition that a use purpose of communication is data communication,
determines a preamble length of less than 4096 symbols under a condition that a use purpose of the communication is distance-measuring communication or radar communication, and
performs communication with the second communication device by using the determined preamble length.

17. A recording medium for recording a communication program, wherein
the communication program instructs
a computer included in a first communication device which performs communication with a second communication device by using a preamble,
to function as a means for executing communication with the second communication device by using a preamble type which is determined, according to a use purpose of communication, from among a plurality of preamble types that are defined depending on a pulse repetition frequency of the preamble or a length of the preamble.
